(19) United States
(12) Patent Application Publication
(10) Pub. No.: US 2012/0008163 A1
(43) Pub. Date: Jan. 12, 2012

(54) IMAGE FORMING APPARATUS

(75) Inventor: Masayuki Jono, Osaka (JP)

(73) Assignee: SHARP KABUSHIKI KAISHA, Osaka (JP)

(21) Appl. No.: 13/167,959

(22) Filed: Jun. 24, 2011

(30) Foreign Application Priority Data
Jul. 6, 2010 (JP) 2010-153889

(51) Int. Cl. G06K 15/02

(52) U.S. Cl. 358/1.15

(57) ABSTRACT

An image forming apparatus has a storage unit for storing a job-waiting list in which job information of a job in a waiting state among a plurality of jobs received for image forming is registered, and a transitional time within which to transit from a waiting mode to an energy-saving mode; a waiting list control unit for controlling to register to the job-waiting list the job information of the job instructed to act within a predetermined count period, when a job is being in progress, and controlling to store into the storage unit a time within which to initially register the job information to the job-waiting list; an accumulation-time count unit for, in the case where it is determined that all the job information stored in the job-waiting list has been absent, counting an accumulation time obtained by accumulating an elapsed time, in the predetermined count period, the elapsed time being counted from a time when the job information is registered to the job-waiting list to a time when all the job information registered in the job-waiting list has been absent after start of processing of the last job registered in the job-waiting list; and a transitional-time set unit for setting the transitional time based on the counted accumulation time.

### CROSS-REFERENCE TO RELATED APPLICATION

This application is related to Japanese patent application No. 2010-153889 filed on Jul. 6, 2010 whose priority is claimed under 35 USC §119, the disclosure of which is incorporated by reference in its entirety.

### BACKGROUND OF THE INVENTION

1. Field of the Invention

The present invention relates to an image forming apparatus such as a copying machine and a printer, and, more particularly, to an image forming apparatus with an energy-saving mode for saving power consumption while it is not in use.

2. Description of the Related Art

Conventionally, in an image forming apparatus with an energy-saving mode for saving power consumption while it is not in use, there has been such an image forming apparatus of the type in which a transitional time from a waiting state (referred to as a “waiting mode” or “operation-waiting state”) for instantly operating any job including copying or the like into the energy-saving mode is manually selected by the operator.

Also, there has been such an image forming apparatus of another type in which a transitional time from the waiting mode into the energy-saving mode is automatically selected as corresponding to a past frequency of usage.

For example, Patent Document 1 as described below discloses an image forming apparatus of the type in which a time (waiting time) from the operation-waiting state to the energy-saving mode is automatically selected and altered in accordance with actual frequency of usage in every time zone or every day of the week. In particular, Patent Document 1 discloses that the waiting time is set to be longer, when it belongs to a time zone of a high frequency of usage with respect to the time zone or day of the week, and, on the other hand, the waiting time is set to be shorter, when it belongs to another time zone of a low frequency of usage, to thereby increase an energy-saving effect.

Also, Patent Document 2 as described below discloses an image forming apparatus of the type in which by storing a state transition from the waiting mode and the energy-saving mode, a most preferable transitional time to the energy-saving mode is simulated and calculated using a transitional time from the waiting mode to the energy-saving mode; recovery times from the energy-saving mode; a reference value of power consumption in each energy-saving mode preliminarily stored; and a reference value of power consumption consumed for recovering to the waiting mode.

Patent Document 2 also discloses that the transitional time is optimized in view of the frequency of usage in every time zone or every day of the week.

### Patent Document

Patent Document 1: Japanese Unexamined Patent Application No. 2004-101919
Patent Document 2: Japanese Unexamined Patent Application No. 2008-72391

In such a conventional apparatus, because present and future transitional times are estimated using information corresponding to the actual frequency of usage in the past, an energy-saving effect may be high if the usage of the apparatus with a same tendency of usage is repeated on a same day of the week or a same time zone for a long time period.

However, the energy-saving effect or the convenience of the operator can be reduced, if the usage of the apparatus in a short time period is largely different from the past tendency of usage.

For example, if the image forming apparatus is hardly operated in a usual Saturday and Sunday, the past tendency of usage is considered so that a transitional time (a waiting time) from a waiting mode to an energy-saving mode is set to be short, whereby the energy-saving mode is instantly shifted, but, on the contrary, it takes long to recover from the energy-saving mode to the waiting mode.

In such a case, if the image forming apparatus is frequently operated at Saturday and Sunday of the last days of a month abruptly, there is a strong possibility that the operator for operating the image forming apparatus at Saturday and Sunday of the last days of the month are kept waiting for the recovery from the energy-saving mode to the waiting mode. Then, the convenience of the operator may be largely damaged.

Further, under the condition that the waiting time is set long at Saturday and Sunday based on the past information of high frequency of usage at Saturday and Sunday of the last days of the month, even if the image forming apparatus is hardly operated at Saturday and Sunday next to the last days of the month, the waiting time set is long enough to take much time to shift to the energy-saving mode, to thereby provide a strong likelihood of damaging the energy-saving effect.

Thus, in the case where the transitional time to the energy-saving mode is set based on the past information of the frequency of usage or the like, if the present state of usage does not correspond to but is largely different from the set transitional time, the energy-saving effect or the convenience of the operator may be damaged.

Accordingly, it is preferable that a transitional time be selected as corresponding to the present state of usage as much as possible, in order to offer both the energy-saving effect and the convenience of the operator.

### SUMMARY OF THE INVENTION

The present invention is provided as an image forming apparatus for dynamically setting a transitional time to an energy-saving mode as corresponding to the latest state of usage as much as possible.

According to a first aspect of the present invention, an image forming apparatus is provided which comprises a storage unit for storing a job-waiting list in which job information of a job in a waiting state among a plurality of jobs received for image forming is registered, and a transitional time within which to transit from a waiting mode to an energy-saving mode; a waiting list control unit for controlling to register to the job-waiting list the job information of the job instructed to act within a predetermined count time, when another job is being in progress, and controlling to store into the storage unit a time within which to initially register the job information to the job-waiting list; an accumulation-time count unit for, in the case where it is determined that all the job information stored in the job-waiting list has been absent, counting an accumulation time obtained by accumulating an elapsed time, in the predetermined count period, the elapsed time being counted from a time when the job information is registered to the job-waiting list to a time when all the job information registered in the job-waiting list has been absent after start of processing of the last job registered in the job-waiting list; and

a transitional-time set unit for setting the transitional time based on the counted accumulation time.

With the above configuration of the present invention, the transitional time to the energy-saving mode is dynamically set as corresponding to the latest state of usage, such that it is possible to adapt a suitable value for optimizing both the energy-saving effect and the convenience of the operator in an almost real-time.

### BRIEF DESCRIPTION OF THE DRAWINGS

FIG. 1 is a schematic sectional view of an image forming apparatus according to a preferred embodiment of the present invention;

FIG. 2 is a block diagram of the image forming apparatus according to the preferred embodiment of the present invention;

FIG. 3-1 is an explanation diagram illustrating a specific example of updating a transitional time to an energy-saving mode according to the present invention;

FIG. 3-2 is an explanation diagram illustrating a specific example of updating a transitional time to an energy-saving mode according to the present invention;

FIG. 3-3 is an explanation diagram illustrating a specific example of updating a transitional time to an energy-saving mode according to the present invention;

FIG. 3-4 is an explanation diagram illustrating a specific example of updating a transitional time to an energy-saving mode according to the present invention;

FIG. 3-5 is an explanation diagram illustrating a specific example of updating a transitional time to an energy-saving mode according to the present invention;

FIG. 3-6 is an explanation diagram illustrating a specific example of updating a transitional time to an energy-saving mode according to the present invention;

FIG. 3-7 is an explanation diagram illustrating a specific example of updating a transitional time to an energy-saving mode according to the present invention;

FIG. 4 is a flowchart illustrating a count operation to count a job-waiting time according to a preferred embodiment of the present invention;

FIG. 5 is a time chart illustrating job operation steps according to a preferred embodiment of the present invention; and

FIG. 6 is a functional block diagram of the image forming apparatus for explaining the function of the image forming apparatus according to the preferred embodiment of the present invention.

### DETAILED DESCRIPTION OF THE PREFERRED EMBODIMENTS

According to a second aspect of the present invention, an image forming apparatus is provided which comprises a reception unit for receiving job instruction for image forming; a storage unit for storing a transitional time within which to transit from a waiting mode to an energy-saving mode in the case of continuing a condition without receiving the job instruction, job information of a received job, a job-waiting list registering the job information of a job being in a waiting state, and a start time Ts within which to start to use the job-waiting list; a determination unit for determining whether or not the job being in progress is present; a waiting list control unit for, in the case where the reception unit receives a request for processing of a first job and the determination unit determines that a second job is being in progress, controlling to register to the job-waiting list the job information of the first job, and controlling to store to the storage unit a time when that job information is registered to the job-waiting list as the start time Ts; a job-waiting determination unit for determining whether or not the job-waiting list has the job information; a job-starting determination unit for, in the case where the job-waiting determination unit determines that the job-waiting list has the job information, determining whether or not processing of the job determined to be in the job-waiting list is started; a starting-time set unit for, in the case where the job-starting determination unit determines that processing of the job is started, setting a starting time when the processing of the job is started as the latest job starting time Td; a waiting-time count unit for, in the case where the job-waiting determination unit determines that the job information is absent in the job-waiting list, counting an elapsed time (Td-Ts) from the start time Ts stored in the storage unit to the latest job-starting time Td; an accumulation-time count unit for counting an accumulation time tr in a predetermined count period by accumulating the transitional time counted by the waiting-time count unit; and a transitional-time set unit for setting the transitional time based on the counted accumulation time.

Also, according to a feature of the present invention, the accumulation time accumulated in the predetermined count period is set to the transitional time, upon the termination of the predetermined count period.

Further, according to the feature of the present invention, the predetermined count period is stored in the storage unit such that the predetermined count time is changeable.

With this configuration, the transitional time to the energy-saving mode is dynamically set as corresponding to the latest state of usage, such that it is possible to optimize both the energy-saving effect and the convenience of the operator.

According to a third aspect of the present invention, a program allowing a computer to perform the following functions is provided which comprises a storage function for storing a job-waiting list in which job information of a job in a waiting state among a plurality of jobs received for image forming is registered, and a transitional time within which to transit from a waiting mode to an energy-saving mode; a waiting list control function for controlling to register to the job-waiting list the job information of the job instructed to act within a predetermined count time, when another job is being in progress, and controlling to store a time within which to initially register the job information to the job-waiting list; an accumulation-time count unit for, in the case where it is determined that all the job information stored in the job-waiting list has been absent, counting an accumulation time obtained by accumulating an elapsed time, in the predetermined count period, the elapsed time being counted from a time when the job information is registered to the job-waiting list to a time when all the job information registered in the job-waiting list has been absent after start of processing of the last job registered in the job-waiting list; and

a transitional-time set function for setting the transitional time based on the counted accumulation time.

The present invention will be described in detail below with reference to the accompanying drawings. It should be understood that the following description is illustrative of the invention in all aspects, but not limitative of the invention.

### <Functional Explanation of an Image Forming Apparatus of the Present Invention>

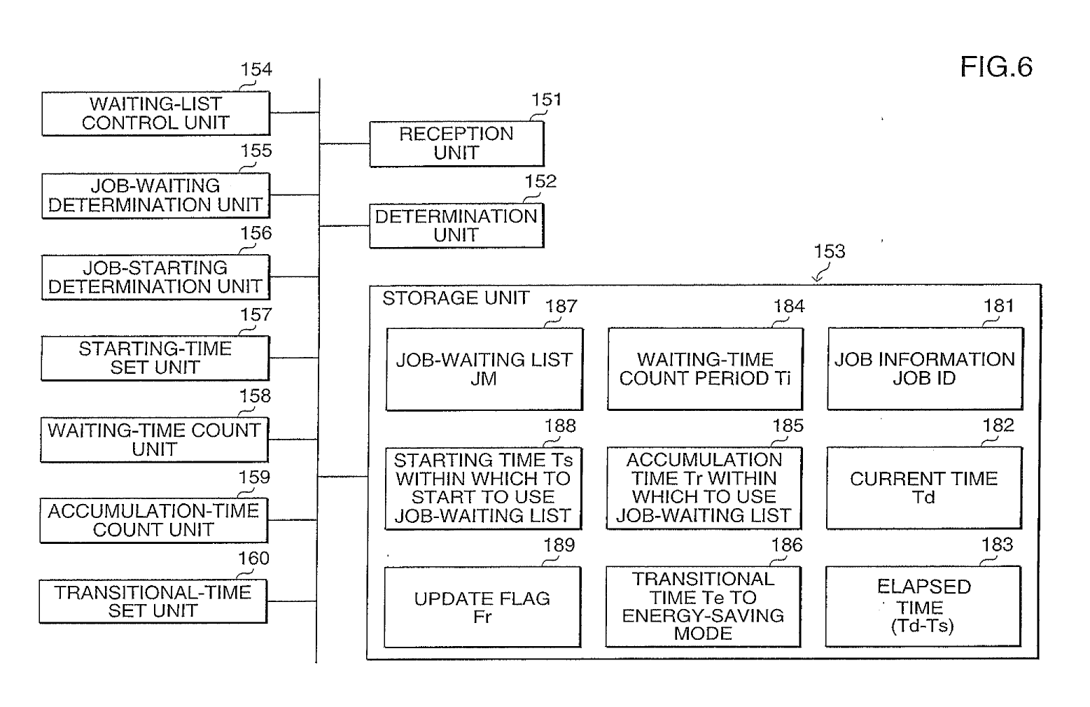

FIG. 6 is a functional block diagram of an image forming apparatus for explaining the function of the image forming apparatus according to a preferred embodiment of the present invention.

Primary functional blocks only are illustrated in FIG. 6 among all the parts of the image forming apparatus.

Namely, the primary functional blocks shown include functions necessary for receiving jobs, determining job-waiting conditions and job-starting conditions, and counting various times about waiting-jobs.

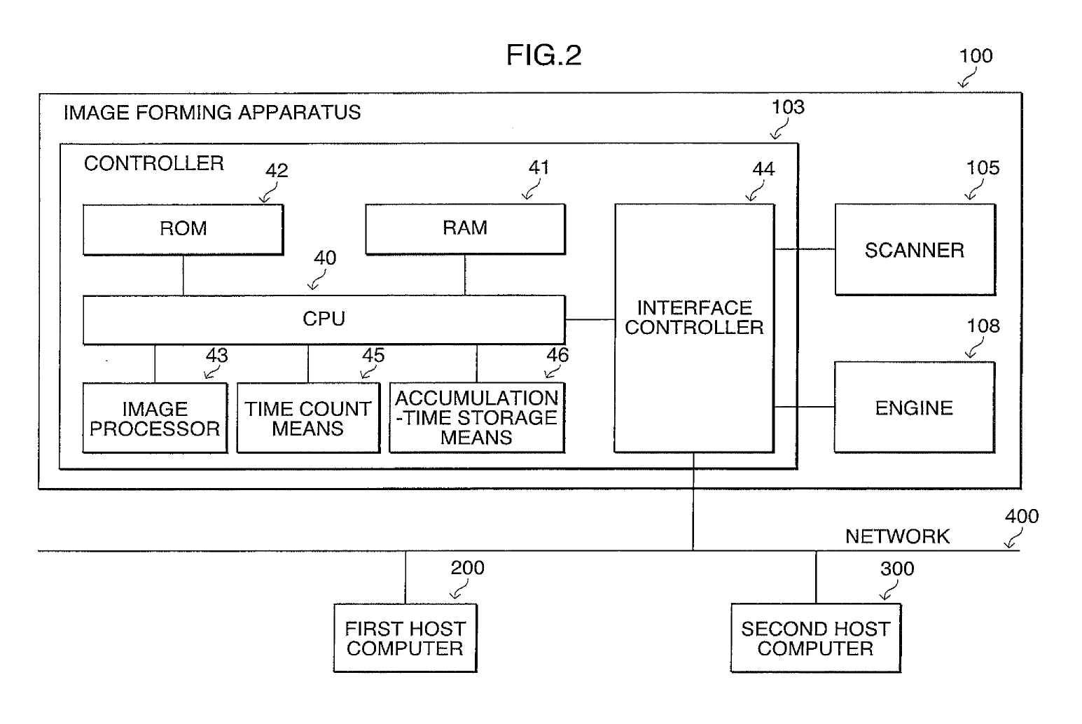

The functional blocks corresponding to the scanner and the engine of FIG. 2 as described below are omitted.

These functional blocks can be embodied by the hardware, but the functional blocks (151, 152 and 154-160) other than a storage unit 153 are embodied by a CPU of FIG. 2.

The functions of the respective functional blocks are embodied by the operation that the CPU organically operates each hardware based on a program stored in a memory including a ROM or the like.

In FIG. 6, a reception unit 151 is a part for receiving job instructions for image-forming. It corresponds to an interface controller 44 for receiving job instructions sent from a scanner, an engine or a network in FIG. 2 as described below.

The data contained in the received job instructions are stored into the storage unit 153 as job information 181.

A determination unit 152 is a part for determining whether the job presently being in progress by the image forming apparatus is present or absent. For example, it is a part for determining whether or not a copy instruction from the scanner is being in progress.

In the case where the reception unit 151 receives an instruction to act one job (a first job) and also the determination unit 152 determines that another job (a second job) presently being in progress is present, a waiting-list control unit 154 is a part for registering the received first job information into a job-waiting list 187 of the storage unit 153 and for further storing to the storage unit 153 a time within which to register the received first job information to the job-waiting list 187 as “a starting time Ts (188) within which to start to use the job-waiting list”.

Namely, the waiting-list control unit 154 is a part for temporarily storing to the storage unit 153 a piece of job information whose job is placed in a waiting state.

The job-waiting list (JM) 187 of the storage unit 153 is a list table for temporarily storing the job information whose job is currently placed in the waiting state. When a plurality of jobs are placed in the waiting state, the waiting jobs are stored in a time series order. The job information stored in the job-waiting list 187 comprises an identification ID to identify the job and a registration time in which to register the job information as described below.

A job-waiting determination unit 155 is a part for determining whether or not the job-waiting list 187 has the job information, Namely, it is a part for checking whether or not the job currently being in the waiting state is present by checking the contents of the job-waiting list 187.

A job-starting determination unit 156 is a part for determining whether or not the action of the job information determined to be present is actually started to act, when the job-waiting determination unit 155 determines that the job-waiting list 187 has some job information. By the determination of the job-starting determination unit 156, it is identified which piece of the job information is actually started to act among a plurality of pieces of the job information in the job-waiting list 187.

When a job A is actually started to act, the job A has not been in the waiting state anymore, so that the job information related to the job A is deleted from the job-waiting list 187.

A starting-time set unit 157 is a part for setting a current time within which to start to act the job to be a starting time within which to start to act the job as “a starting time Td within which to start to act the latest job”, in the case where the job-starting determination unit 156 determines that the job is started to act. This starting time Td corresponds to a current time to be set.

The starting-time set unit 157 deletes the job information from the job-waiting list 187, when the job actually started to act is contained in the job-waiting list 187.

A waiting-time count unit 158 is a part for counting an elapsed time (Td-Ts) from “the starting time Ts (188) within which to start to use the job-waiting list” to “the starting time Td within which to start to act the latest job”, when the job-waiting determination unit 155 determines that the job-waiting list 187 has no piece of the job information.

In the preferred embodiments of the present invention as described below, it is explained that a time within which to determine that a job is started to act corresponds to a time within which to determine that the job-waiting list has no piece of the job information.

The elapsed time (Td-Ts) 183 is stored in the storage unit 153.

An accumulation-time count unit 159 is a part for counting an accumulation time tr by accumulating the transitional time 183 counted by the waiting-time count unit 158 in a predetermined count period.

Herein, the predetermined count period corresponds to “a waiting-time count period” ti (184) stored in the storage unit 153.

By accumulating the elapsed time (Td-Ts) in a period defined by the count period ti, the accumulation time tr in this count period is counted.

The accumulation time tr corresponds to an “accumulation time tr (185) within which to use the job-waiting list” stored in the storage unit 153.

Each time the transitional time 183 is counted, the transitional time 183 is accumulated to the accumulation time tr, so that the accumulation time tr totally can be obtained by tr=tr+(Td-Ts).

A transitional-time set unit 160 is a part for setting a transitional time te from the waiting mode to the energy-saving mode, based on the above-counted accumulation time tr.

Herein, this transitional time te corresponds to “a transitional time te (186) to the energy-saving mode” stored in the storage unit 153.

The transitional time te is set based on the accumulation time tr, but, for example, the transitional time te may be set by the counted accumulation time tr as such. In this case, te=tr.

The storage unit 153 is a part for storing the information (181-189) as mainly illustrated in FIG. 6 and is constructed by a semiconductor memory such as ROM and RAM, and a storage device such as a hard disk.

The information to be permanently stored among the stored information may be memorized in a read-only memory such as ROM. Also, changeable information such as the job information 181, the job-waiting list JM 187 and an update flag 189 may be memorized in a random access memory (RAM).

The functional block diagram or the information to be stored as shown in FIG. 6 should not be limited thereto, but may be added or deleted as necessary.

### <Explanation of Unital Structure of the Image Forming Apparatus>

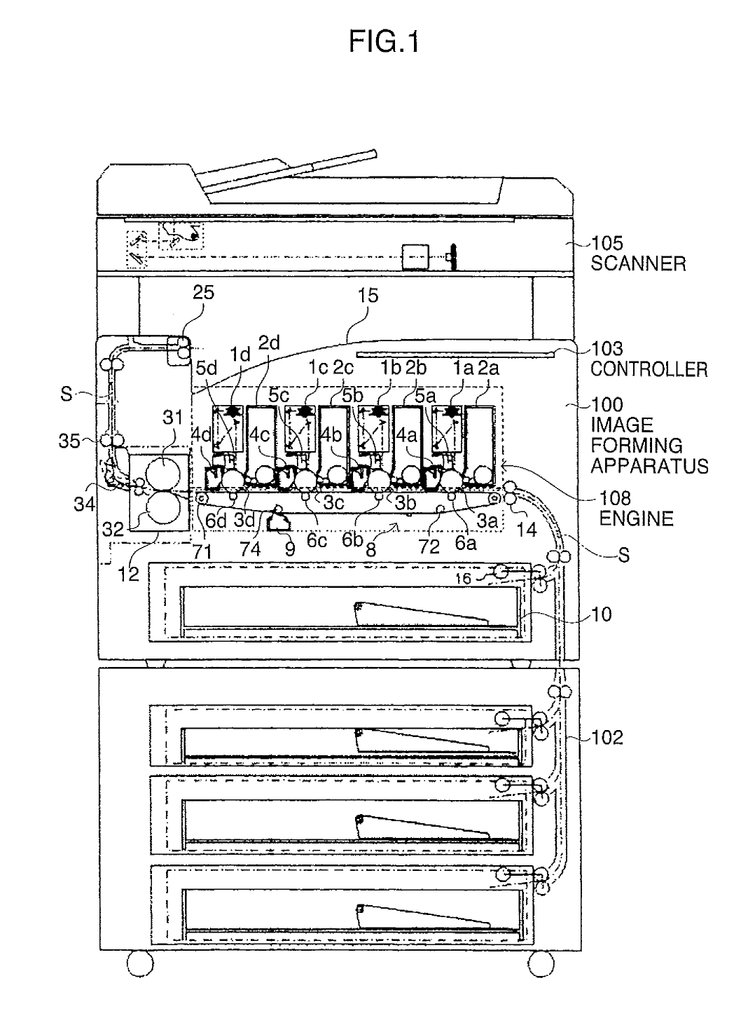

FIG. 1 is a schematic sectional view of an image forming apparatus according to a preferred embodiment of the present invention.

The image forming apparatus as illustrated in FIG. 1 is used as a Multi-Function-Peripheral (MFP) and is, so-called, a color copying machine.

The image forming apparatus 100 prints a multi-color and a mono-color image onto a predetermined sheet (recording sheet) in accordance with image data externally transmitted.

As shown in FIG. 1, the image forming apparatus 100 comprises an engine 108 mainly including exposure units 1 (1a, 1b, 1c, 1d); developing units 2 (2a, 2b, 2c, 2d); photoconductor drums 3 (3a, 3b, 3c, 3d); cleaner units 4 (4a, 4b, 4c, 4d); chargers 5 (5a, 5b, 5c, 5d); a transfer-and-carrier-belt unit 8; a fixing unit 12; and a sheet transporting path S or the like, a sheet feeding tray 10, a sheet exit tray (sheet piling unit) 15, a scanner 105, a controller 103, and a sheet supply device 102 or the like.

The image date handled by the image forming apparatus 100 include a color image using four colors of black (K), cyan (C), magenta (M), and yellow (Y). Therefore, in FIG. 1, four exposure units 1 (1a, 1b, 1c, 1d), four developing devices 2 (2a, 2b, 2c, 2d), four photoconductor drums 3 (3a, 3b, 3c, 3d), four charging devices 5 (5a, 5b, 5c, 5d), and four cleaner units 4 (4a, 4b, 4c, 4d) are provided so as to form four types of latent images corresponding to the four colors. Each of these devices affixed by “a”, “b”, “c”, and “d” is set to black, cyan, magenta, and yellow respectively, whereby four image stations are structured respectively.

The photoconductor drums 3 for the respective colors are positioned almost at the central portion of the image forming apparatus 100.

Each of the charging devices 5 is a charging means for uniformly charging a surface of each of the photoconductor drums 3 with a predetermined potential. A contact roller type charging device, a brush type charging device or a charger type charging device as illustrated in FIG. 1 may be employed.

The exposure unit 1 is configured as a laser scanning unit (LSU) including an optical writing head having light-emitting elements such as EL or LED arranged in an array, or an image writing device provided with a laser emitting unit and a reflection mirror.

The exposure unit 1 comprising the light-emitting elements, each of which emits a laser beam for black (K), cyan (C), magenta (M), and yellow (Y) independently, emits the laser beams to the photoconductor drums 3 of the respective color which are charged, whereby a light exposure is performed corresponding to the input image. With this exposure, an electrostatic latent image corresponding to the image data of each color is formed on the surface of each of the photoconductor drums 3.

Each of the developing devices 2 makes the electrostatic latent image, which is formed on the peripheral surface of each of the photoconductor drums 3, visible with a toner of each color of black (K), cyan (C), magenta (M), and yellow (Y).

Each of the cleaner units 4 removes and collects a residual toner on the surface of each of the photoconductor drums 3 after the development and the image transfer.

The transfer-and-carrier-belt unit 8 is arranged below the photoconductor drums 3. The transfer-and-carrier-belt unit 8 includes a transfer belt 7, a transfer-belt drive roller 71, a transfer-belt tension roller 72, a transfer-belt drive roller 73, a transfer-belt support roller 74, transfer rollers 6 (6a, 6b, 6c, 6d), and a transfer-belt cleaning unit 9.

The transfer-belt drive roller 71, the transfer-belt tension roller 72, the transfer roller 6, the transfer-belt drive roller 73, and the transfer-belt support roller 74 or the like are provided for rotating the transfer belt 7 in the arrow B during extending it.

The transfer rollers 6 are rotatively supported by inner frames (not shown) of the transfer-and-carrier-belt unit 8, so that the toner images on the photoconductor drums 3 are transferred into a sheet (recording sheet) absorbed and carried on the transfer belt 7.

The transfer belt 7 is arranged to come in contact with the photoconductor drums 3 (3a, 3b, 3c, 3d), along a rotating direction thereof. The toner images of the respective color components formed on the peripheral surfaces of the photoconductor drums 3 are successively superimposed and transferred, one by one, on the sheet (recording sheet). As a result, a color toner image (multi-color toner image) is formed onto the sheet (recording sheet). The transfer belt 7 is an endless belt using a resinous film with a thickness of about 100 μm.

The toner images from the photoconductor drums 3 to the sheet (recording sheet) are transferred by the transfer roller 6 being in contact with the back side of the transfer belt 7. A high voltage is applied to the transfer roller 6 for transferring the toner images, the high voltage having a positive polarity (+) reverse to a negative polarity (−) of the charged toners.

The transfer roller 6 is made of a base material of a metal shaft (e.g., stainless) of 8-10 mm in diameter, covered with a conductive elastic material. The conductive elastic material of the transfer roller 6 provides uniformly the high voltage to the sheet (recording sheet), In the preferred embodiment of the present invention as shown in FIG. 1, the transfer roller 6 is used for transference electrodes, but may be used for a brush, instead.

The toners adhered to the transfer belt 7 by being in contact with the photoconductor drums 3 are removed and collected by the transfer-belt cleaning unit 9 so as not to dirt the back surface of the recording sheet. The transfer-belt cleaning unit 9 has a cleaning blade provided for removing and collecting residual toner on a surface of the transfer belt 7 by being in contact with the transfer belt 7. The transfer belt 7 being in contact with the cleaning blade is supported from the backside by the transfer-belt support roller 74.

The sheet feeding tray 10 is provided for storing sheets (recording sheets) used for the image formation, and provided below the engine 108 of the image forming apparatus 100. The sheet exit tray 15 provided at the upper portion of the image forming apparatus 100 is provided for piling the printed sheets face-down (the sheets for recording the images are piled with surfaces for recording the images being down).

In the preferred embodiment of the present invention as shown in FIG. 1, the sheet exit tray 15 is structured to be for face-down, but should not be limited thereto.

It is possible that the recording sheets are discharged either face-down or face-up by providing a paper-reversing mechanism in a sheet transporting path along which the sheets are discharged to the sheet exit tray 15.

The sheet transporting path S whose shape is like an S-letter is provided in the image forming apparatus 100 for transporting the sheets from the sheet feeding tray 10 to the sheet exit tray 15 via the transfer-and-carrier-belt unit 8 and the fixing unit 12. A pickup roller 16, registration rollers 14, the fixing unit 12, a transport direction switching gate 34, and carrier rollers 25 for carrying the sheets, or the like are arranged adjacent to the sheet carrying path S from the sheet feeding tray 10 to the sheet exit tray 15.

The carrier rollers 25 are small rollers provided for accelerating and assisting the transportation of the sheets. A plurality of the carrier rollers 25 are provided along the sheet carrying path S. The pickup roller 16 is arranged at the end of the sheet feeding tray 10 for picking up and supplying the sheets from the sheet feeding tray 10 to the sheet carrying path S, one by one.

The registration roller 14 is provided for temporarily stopping the sheet, which is transported through the sheet carrying path S. Then, the registration roller 14 is provided for carrying the sheet in a good time so as to be in synchronization with the rotation of the photoconductor drums 3, in order that the toner images formed on the photoconductor drums 3 are multiplexly transferred on the sheet properly.

That is, the registration roller 14 is responsive to a detection signal outputted by a fore-registration detection switch (not shown) for carrying to align the leading edge of the toner images to that of the image forming area in the sheet.

The fixing unit 12 mainly includes a heat roller 31 and a pressure roller 32. The heat roller 31 and the pressure roller 32 rotate as nipping the sheet.

Also, the heat roller 31 is structured to be in a predetermined fixing temperature by a temperature control unit based on a temperature-detection value from a temperature detector (not shown). When the heat roller 31 and the pressure roller 32 press the recording sheet together with heating it, the multi-color toner image transferred onto the sheet is fused, mixed, and pressed to be fixed onto the sheet.

The sheet with the multi-color toner image transferred onto is transported to a sheet-reverse discharge path of the sheet carrying path S by the carrier roller 25, and the reversed sheet is discharged on the sheet exit tray 15 with the multi-color toner image being face-down.

For the scanner (document reading apparatus) 105, a document platen made of a transparent glass, on which a document is placed, is mounted at an upper portion of the scanner 105. An automatic document feeder is mounted above the document platen. The automatic document feeder is provided for automatically transporting a plurality of documents set on a document set tray one-by-one onto the document platen.

The scanner 105 is provided for scanning and reading the document placed onto the document platen. For this purpose, the scanner 105 comprises a first scanning unit, a second scanning unit, an optical lens, and a CCD line sensor as a photoelectric transducer element (all not shown). The first scanning unit includes a light exposure lamp unit for light-exposing the document platen, and a first mirror for reflecting the light image reflected from the document to a predetermined direction. The second scanning unit includes a second and third mirrors for reflecting the reflected light image of the document reflected from the first mirror into the CCD line sensor as the photoelectric transducer element. The optical lens is provided for focusing the light image reflected from the document onto the CCD line sensor.

Also, the scanner 105 is provided for, in an operation correlated with the automatic document feeder, reading the document automatically fed by the automatic document feeder, producing the image data of the document and forwarding it to the controller 103 as described below. The image data are processed with image processing by an image processing unit 43 of the controller 103, so that the processed image data are once stored in a RAM 41 of the controller 103. In response to the output instruction, further, the image data are read out from the RAM 41 and transported to the engine 108.

Although the image forming apparatus with the automatic document feeder is exemplified in FIG. 1, it should not be limited thereto. It is unnecessary to provide the automatic document feeder. Further, in the preferred embodiment of the present invention of FIG. 1, the sheet supply device 102 is a type of three floors, but should not be limited thereto. It may be a type of one floor or a tandem tray including two trays in parallel, or simply a desk style or the like. Any type of sheet supply tray should be adapted to the image forming apparatus according to the preference of the user.

### <Construction of the Image Forming Apparatus>

The image forming apparatus of the present invention will be described in detail below. FIG. 2 is a block diagram of the image forming apparatus 100 according to the preferred embodiment of the present invention.

The image forming apparatus 100 is interconnected to a plurality of host computers 200 and 300 via a network 400 including LAN or the like.

As shown in FIG. 2, the image forming apparatus 100 comprises a controller 103, a scanner 105, and an engine 108, mainly. Here, the scanner 105 and the engine 108 are the same as those in FIG. 1. The controller 103 is provided for performing prescribed image processing to the image data inputted by the scanner 105, so that the multi-color or mono-color toner image is produced on the sheet (recording sheet).

Otherwise, the controller 103 is provided for receiving job instruction including a print or the like from the first host computer 200 interconnected via the network 400, and for producing the multi-color or mono-color toner image on the sheet (recording sheet).

The controller 103 comprises a CPU 40, a RAM 41, a ROM 42, an image processor 43, an interface controller 44, a time count means 45, and an accumulation-time storage means 46.

The CPU 40 is a part corresponding to a microprocessor for controlling the RAM 41, the ROM 42 and the peripheral devices, and is a part for performing the respective functions of the image forming apparatus 100 of the present invention based on a program stored in the ROM 42 or the like.

The RAM 41 connected to the CPU 40 functions as a work area for image processing or as a memory device for temporarily storing the image data. A volatile memory such as DRAM is used for the RAM 41.

The ROM 42 is a memory device for storing the program performed by the CPU 40. A nonvolatile memory such as a flash memory is used for the ROM 42.

The interface controller 44 is a part for receiving job instructions and job data from e.g., the host computers 200 and 300 in the network 400. It has a telecommunication function and corresponds to a receiving unit. Further, it receives the image data read by the scanner 105 and outputs it to the CPU 40.

Further, the interface controller 44 is responsive to the output instructions from the CPU 40 for reading out the image data from the RAM 41, which are image-processed by the image processor 43, and for transporting it to the engine 108.

The job data received by the host computers 200 and 300 are transported to the CPU 40, so that the job data are analyzed based on the received job instruction to be thereby transferred to the image data. The transferred image data are temporarily stored in the RAM 41.

Also, the image data inputted by the scanner 105 are temporarily stored in the RAM 41 after being image transference.

The image processor 43 is a part for performing the prescribed image processing to the image data inputted via the interface controller 44, namely, e.g., producing the image data corresponding to each of the colors which are capable to be printed. The produced image data are stored in the RAM 41.

The time count means 45 is responsive to the instruction from the CPU 40 for counting a waiting time from a job-instruction time, when the job instruction is received from the scanner 105 or the host computers 200 and 300, to a job-action time, when the CPU 40 actually starts to act the job. It corresponds to, so-called, a real time clock.

The accumulation-time storage means 46 is a part for accumulating the waiting time counted by the time count means 45. For example, a nonvolatile memory such as EEPROM is used for the accumulation-time storage means 46.

### <Count Operation of the Present Invention for Counting Job-Waiting Times>

A count operation for counting job-waiting times according to a preferred embodiment of the present invention will be described below. Here, the variables used in the count operation are defined as follows:

te: a transitional time to the energy-saving mode

tr: an accumulation time within which to use the job-waiting list

ti: a waiting-time count period

Td: a current time

Ts: a starting time within which to start to use the job-waiting list

fr: an update flag (0: initial condition (no updated), 1: updated)

The “transitional time (te) 186 to the energy-saving mode” means a transitional time from the waiting mode to the energy-saving mode, when no occurrence of a new job continues in a mode (e.g., a waiting mode) other than the energy-saving mode.

Concretely, after the CPU 40 has finished a job such as a print instruction in a waiting mode, if a time without any other job to act continues, the transitional time (te) means a time from a first time, when the job has been finished, to a second time, when an action to shift to the energy-saving mode is started.

For example, in the case where the “transitional time (te) to the energy-saving mode” is set “5 minutes”, if the time when a job has been finished is 13:10 and, thereafter, a new job instruction does not occur, the next starting time within which to start to shift to the energy-saving mode is 13:15.

The “accumulation time (tr) 185 within which to use the job-waiting list” means an accumulation time within which to accumulate waiting times by the time when a job is actually started to act, if the job instruction occurs but the job information is registered in the job-waiting list because the job cannot be acted.

The “waiting-time count period” (ti) 184 means a count period for counting the “accumulation time (tr) within which to use the job-waiting list”.

Here, when the job being in the waiting state is started to act, the job information is deleted from the job-waiting list, so that it is considered that the time, when the job is actually started to act, is almost equal to a current time when it is determined that any piece of the job information is absent in the job-waiting list.

In more detail, an elapsed time (Td-Ts) is counted from “the starting time (Ts) within which to start to use the job-waiting list”, by initially registering the job information being in the waiting state to the waiting list as described below, into “the current time (Td)” when all the registered pieces of the job information are absent in the job-waiting list by starting to act the jobs whose job information is registered in the job-waiting list. In the waiting-time count period (ti), the counted elapsed time (Td-Ts) is accumulated, so that the accumulated elapsed time (Td-Ts) corresponds to the “accumulation time (tr) within which to use the job-waiting list”.

For example, in the case where the waiting-time count period (ti) is “20 minutes”, if a starting time within which to start to count the “accumulation time (tr) within which to use the job-waiting list” is 14:10, each waiting time within which to wait each job being in the waiting state is accumulated to the “accumulation time (tr) within which to use the job-waiting list” between 14:10 and 14:30.

Herein, a waiting time means an elapsed time (Td-Ts) counted from “the starting time (Ts) within which to start to use the job-waiting list” corresponding to a time when the job information of a job “B” being in the waiting state is registered in the waiting list, into “a starting time” when the job “B” is actually started to act (referred to as “current time (Td)”, herein)

Therefore, the current accumulation time tr is defined tr=tr0+(Td-Ts) where the counted value of the accumulation time stored by the last count operation is tr0 and the accumulated waiting time is (Td-Ts). Such an accumulation is performed within the above “waiting-time count period” (ti).

If a plurality of jobs are received within the above “waiting-time count period” (ti), and are in the waiting states, every one of waiting times for the plurality of jobs is not counted. Otherwise, the elapsed time (Td-Ts) is set in the “accumulation time (tr) within which to use the waiting-list”, the elapsed time (Td-Ts) being counted from “the starting time (Ts) within which to start to use the job-waiting list” into a “current time (Td)” within which to determine that all the registered pieces of the job information is absent in the job-waiting list by starting to act the last job in the waiting list among the plurality of the jobs being in the waiting state registered in the waiting list.

After the above “waiting-time count period” (ti) lapses, the “accumulation time (tr) within which to use the job-waiting list” is reset to the initial value (0), so that a new count period (ti) is started and the counting operation is performed again.

The “starting time (Ts) 188 within which to start to use the job-waiting list” is a registration time when the job information being in the waiting state is registered in the waiting-list under the condition that another job is currently in progress, and the job instruction in question cannot be started instantly.

The “starting time (Ts) 188 within which to start to use the job-waiting list” is stored in the predetermined waiting-time count period ti, when the job information being in the waiting state is initially registered in the waiting-list.

However, the “starting time (Ts)” may be stored each one of registered jobs as a part of the job information.

When a plurality of jobs being in the waiting state are present in the same time zone, the job information is stored in the waiting list in the order that the older job information being in the waiting state is stored in the waiting list more initially.

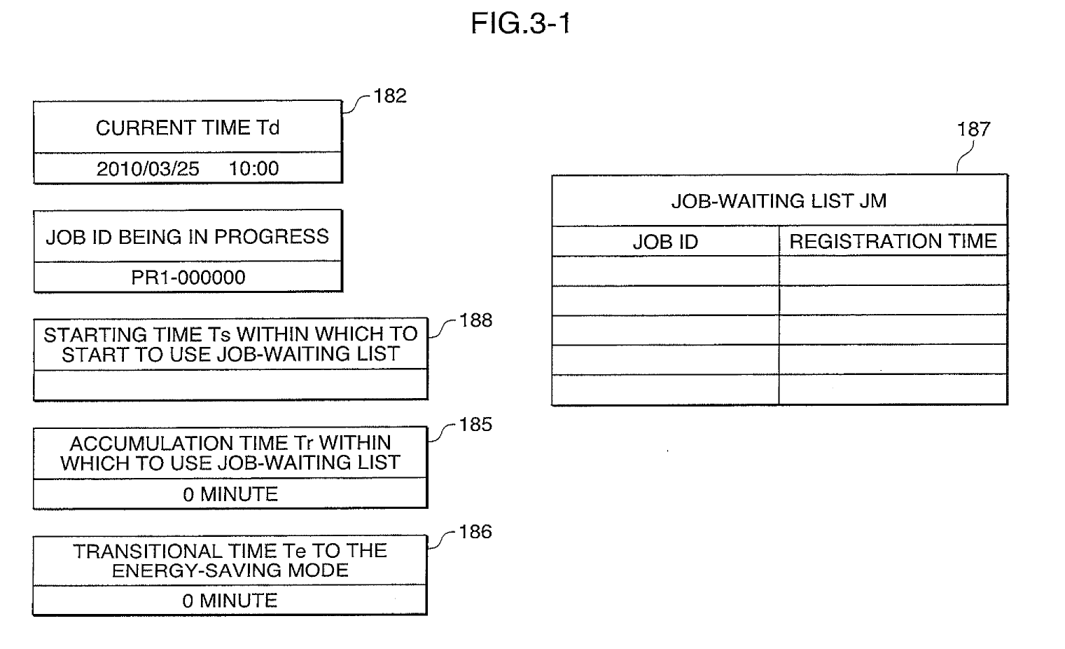

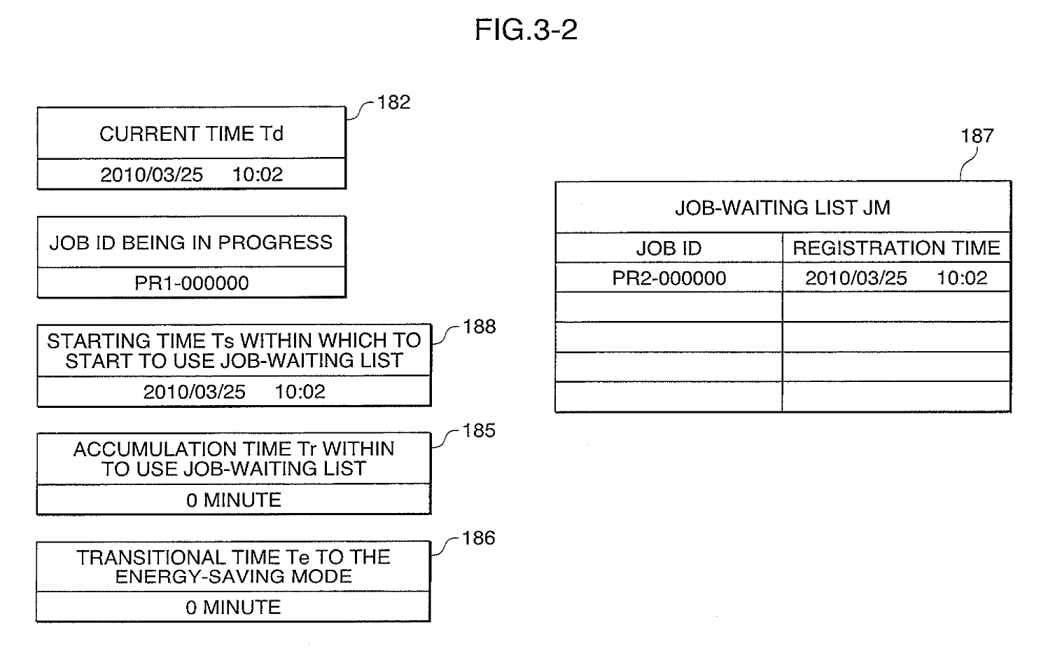

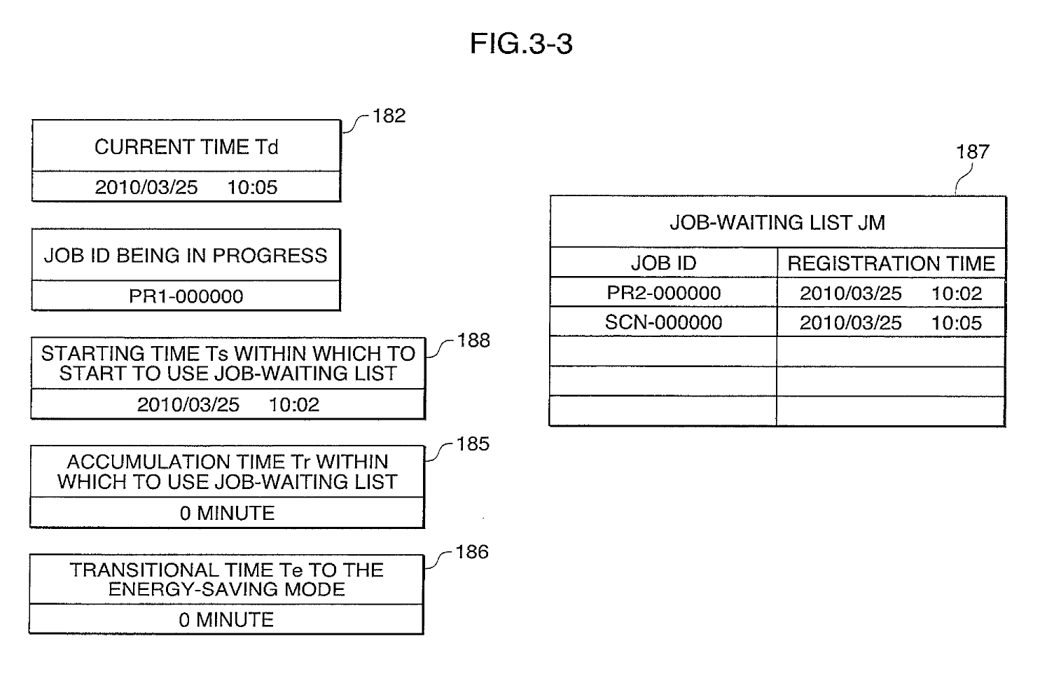

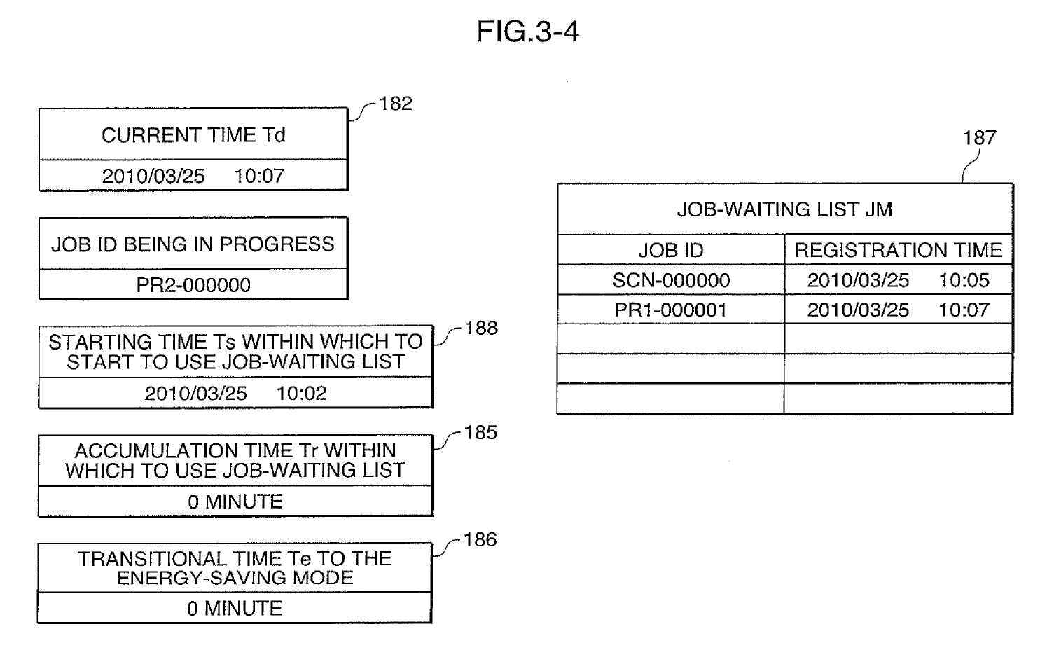

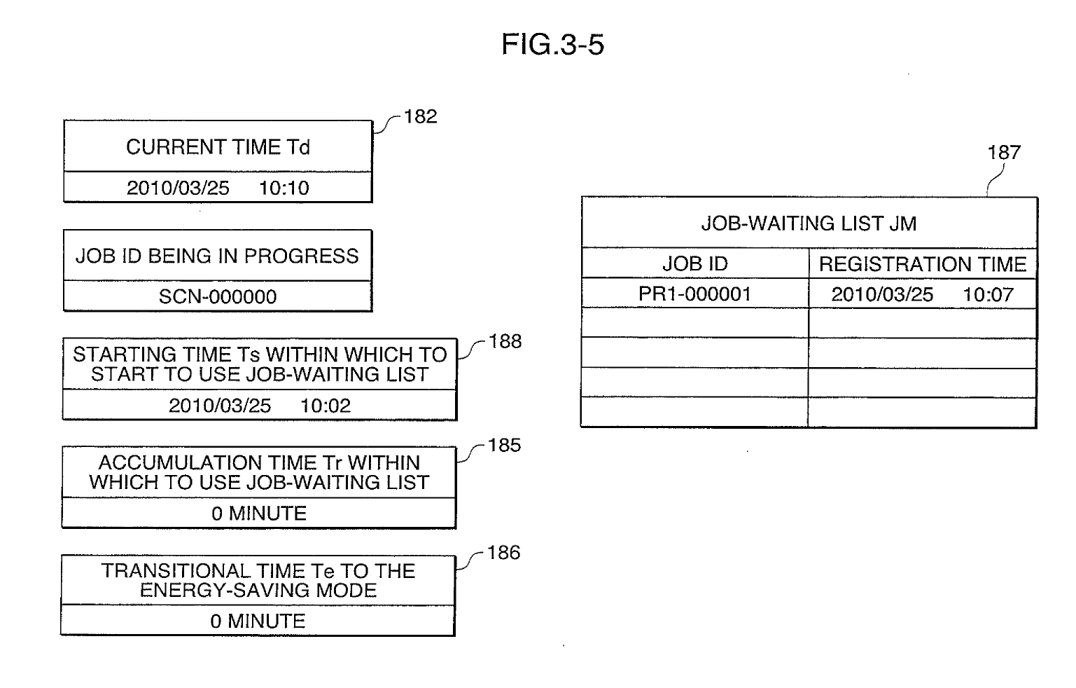

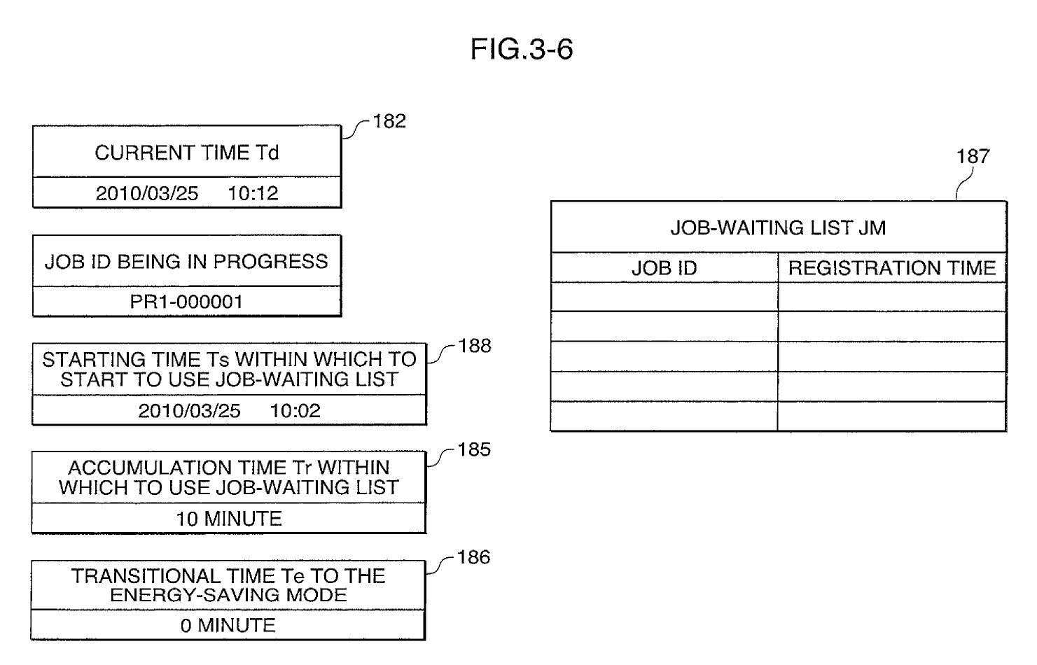

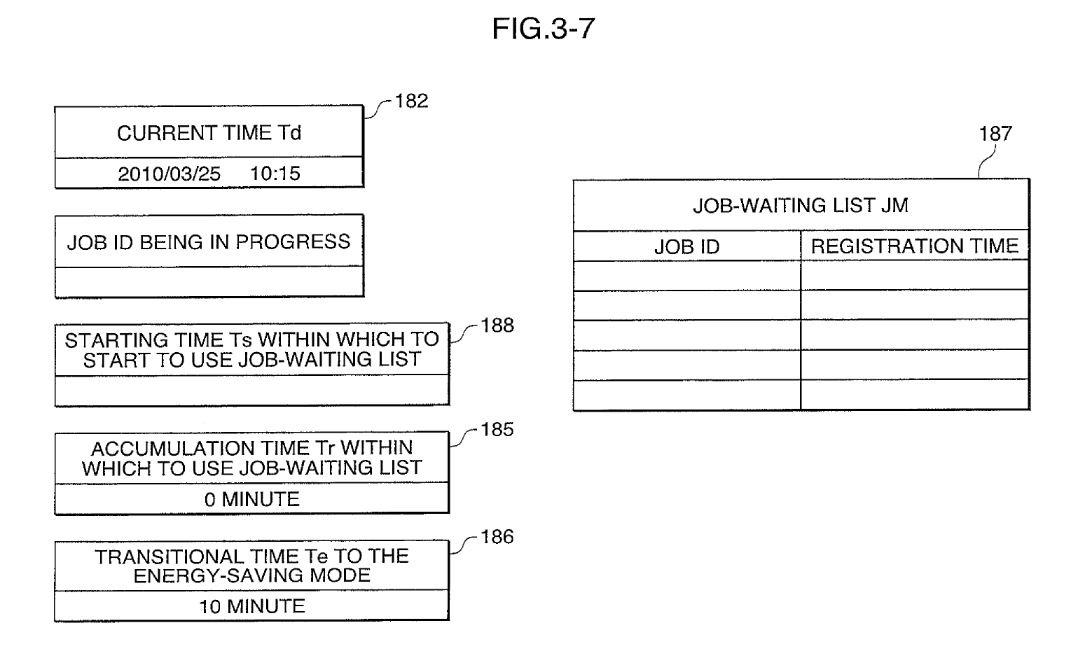

The job information is information stored in the job-waiting list, and as shown in e.g., FIG. 3-1, the job information comprises a job identification (ID) and a registration time. The job identification (ID) is information to identify the job instruction.

The registration time is a time within which to register the job information for each job in the job-waiting list, but the “starting time (Ts) within which to start to use the job-waiting list” corresponds to a time when the job information is initially registered in the job-waiting list among the registration times. However, after the job information is absent in the job-waiting list, a new time is set for the time (Ts).

The current time (Td) 182 is a current time continuously counted by a time count means 45, and includes the year, date, hour, minute, and second information. The current time (Td) 182 is stored in the RAM 41. Otherwise, if the CPU 40 has a timer function, the current time may be recorded using the timer function.

The update flag (fr) 189 is information indicating whether or not the transitional time (te) to the energy-saving mode is updated, indicating that “0” is not updated and “1” is to be updated, for example.

Also, as the initial condition of the update flag (fr) 189, fr=0. When the accumulation time (tr) is newly updated, “1” is set to the update flag (fr).

In the present invention, the waiting mode is a condition that every function of the image forming apparatus of the present invention can be started almost in a real time to perform and that all the hard wares (103, 105, and 108) in FIG. 2 are power-supplied.

In the present invention, the energy-saving mode is another condition that the image forming apparatus can be recovered spontaneously to the waiting mode in which the image forming apparatus acts the job, and that at least necessary hard wares only for this purpose are power-supplied.

For example, if a recovery button is equipped in the image forming apparatus, when the energy-saving mode is selected, only a part of hard ware necessary for detecting that the recovery button is pushed is power-supplied.

Also, in the energy-saving mode, only a part of hard ware necessary for detecting that a job such as a print instruction is received or not via the network 400 is power-supplied.

In FIG. 2, in the energy-saving mode, at least hard ware belonging to the controller 103 is power-supplied.

Accordingly, in the energy-saving mode, the power supply to the scanner 105 and the engine 108 in FIG. 2 is prevented to thereby enable the power-saving effect.

Also, for example, if some kind of job is received during the energy-saving mode, the reception condition is triggered such that the hard ware prevented from being power-supplied is power-supplied again, thereby recovering a condition (the waiting mode) for starting to act the received job. However, in general, it takes a predetermined time (T) from several seconds to several minutes to establish the condition for actually starting to act the received job.

That is, in the case where the image forming apparatus is conditioned in the energy-saving mode, even if the operator enters an instruction (such as a print), the job cannot be instantly started to act, but is waiting for the predetermined time (T).

Here, if the transitional time (te) to the energy-saving mode is set to be relatively short, when a job has been finished and a new job instruction has not occurred, it is shifted to the energy-saving mode in a short transitional time.

For example, if the transitional time (te) to the energy-saving mode is set to be “0 minute”, when a job has been finished, it is instantly shifted to the energy-saving mode. Namely, every part of hard ware unnecessary in the energy-saving mode is prevented from being power-supplied. In this case, the energy-saving effect is mostly focused so that it is effective to minimize the power consumption as much as possible.

If the transitional time (te) to the energy-saving mode is set to be relatively long, when a job has been finished and no new job instruction has continued, it is hardly shifted to the energy-saving mode, easily.

For example, if the transitional time (te) to the energy-saving mode is set to be “60 minutes”, when a job C has been finished and no new job instruction has continued, the waiting mode for instantly starting to act a job remains for 60 minutes even after the finish of the job C. After 60 minutes lapse, it is shifted to the energy-saving mode.

In other words, this period of 60 minutes is a condition that, notwithstanding acting no job, all parts of hard ware are being power-supplied and that, if the operator enters a new job instruction during this period of 60 minutes, the new job instruction is started to act, instantly.

In this case, the convenience of the operator is mostly focused, so that it is convenient for the operator to instantly start to act the new job instruction without waiting for it. However, it is long to idly consume the power, so that it is difficult to aim the energy-saving effect.

Accordingly, according to the feature of the present invention, the transitional time (te) to the energy-saving mode is not fixedly set to be a value such as “0 minute” or “60 minutes” as described above, but the transitional time (te) to the energy-saving mode is dynamically set as corresponding to the present state of usage.

In particular, for example, in the case where an instruction of a job A is entered, when another job B is being in progress, the job information related to the job A is registered in the job-waiting list and the job A is placed in the waiting state. Then, with respect to one or more jobs registered to the job-waiting list within a predetermined count period ti, an accumulation time tr within which to use the job-waiting list is counted by accumulating an elapsed time counted from a first time Ts when the job information is initially registered to the job-waiting list to a second time when all the job information registered in the job-waiting list has been entirely absent after start of processing of the last job registered in the job-waiting list. Based on the accumulation time tr, a transitional time te to the energy-saving mode is newly set.

Thereby, the transitional time te to the energy-saving mode is dynamically set in view of the latest state of usage close to the present state, so that it is possible to optimize both the energy-saving effect and the convenience of the operator.

### <Count Operation of the Present Invention>

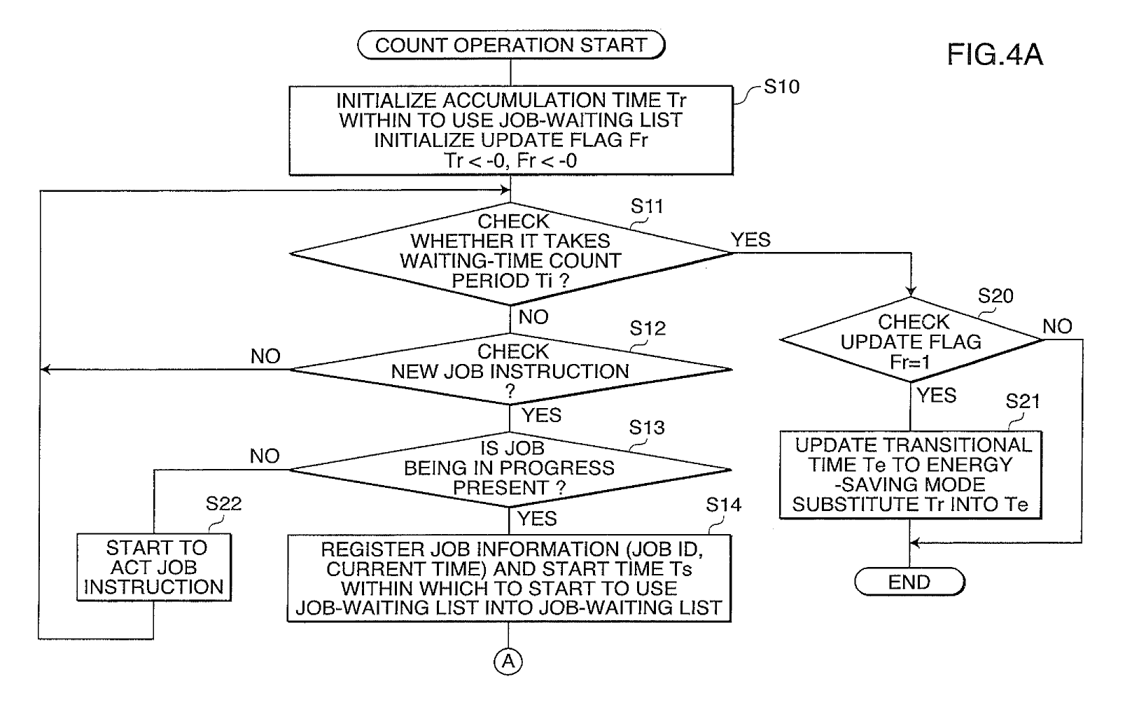

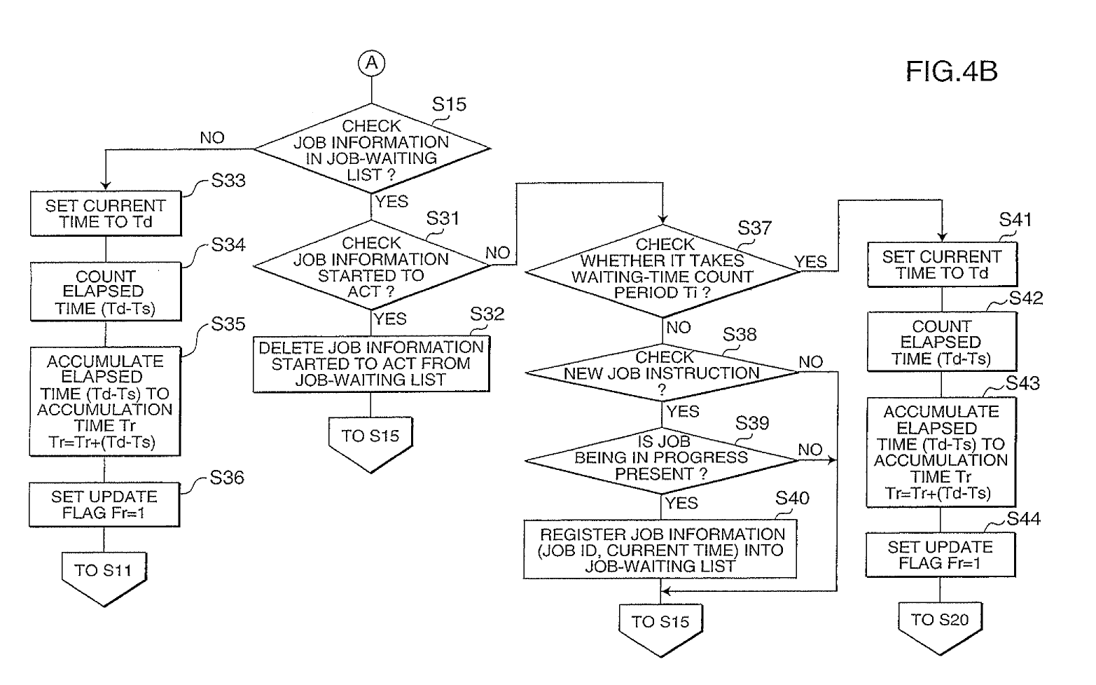

FIG. 4 is a flowchart illustrating count operation to count a job-waiting time according to the preferred embodiment of the present invention.

In this flow chart, an example is explained in which an accumulation time is set as an accumulation time tr within which to use the job-waiting list, the accumulation time being accumulated till the job-waiting list has no piece of the registered job information after initially storing a start time Ts within which to start to use the job-waiting list within a predetermined count period ti.

At first, in step S10, the accumulation time tr within which to use the job-waiting list (185) is initially set to be “0 minute” and the update flag fr (189) is initialized to be “0”. At the initial condition, a start time Ts (188) within which to start to use the job-waiting list is conditioned for storing nothing (e.g., “0”).

Also, a start time within which to start the count operation (a count-starting time t0) is stored so that a count for counting a transitional time from the count-starting time t0 is started. This count value is compared with an waiting-time count period ti (184).

In step S11, it is checked whether or not it takes the waiting-time count period ti starting from the count-starting time t0.

If it takes, step S20 is selected and if not, step S12 is selected. In step S12, it is checked whether or not a reception unit 151 receives a new job instruction.

If it receives the new job instruction, step S13 is selected and if not, the operation is returned to step S11.

One example of the job instruction is, for example, a print instruction sent from the host computers 200 and 300 interconnected via the network 400 or a copy instruction sent from the scanner 105. The instructed job instruction is stored as job information 181 in the storage unit 153.

For example, the interface controller 44 analyzes the reception data from the scanner 105 or the network 400 to determine whether or not the job instruction is newly entered. When the reception data are the copy instruction or the print instruction, it is determined that the job instruction is received. The CPU 40 is responsive to the reception of the copy instruction or the print instruction for starting to act a job corresponding to the job instruction.

In step S13, a determination unit 152 is operated to check whether or not a job being in progress is present.

If it determines that no job is being in progress, step S22 is selected. If it determines that a job being in progress is present, step S14 is selected. In step S22, the CPU 40 starts to act the job instructed in step S12. Then, the operation is returned to step S11.

It is preferable that the job action be actually performed in a multitask operation.

In step S14, a job-waiting list control unit 154 is operated to control to register information (job information) related to the job instruction to the job-waiting list 187. For example, a job identification (ID) to identify the job instruction is registered.

Further, a current time in which to register the job information is stored in the job-waiting list 187 as a registration time as corresponding to the job identification (ID).

Since this stored registration time is a time in which to initially register the job information in the count period ti, it is stored as a start time Ts within which to start to use the job-waiting list (a start time Ts (188) within which to start to use the job-waiting list).

In step S15, a job-waiting determination unit 155 is operated to check whether or not the job-waiting list 187 has the job information being pending. Namely, it checks whether or not the job-waiting list 187 has no piece of the job information being pending.

If it checks that the job-waiting list 187 has at least one piece of the job information being pending, step S31 is selected. If it checks that the job-waiting list 187 has no piece of the job information being pending, step S33 is selected.

In step S31, a job-starting determination unit 156 is operated to check whether or not there is some job information which is started to act by the CPU 40, among the job information remaining in the job-waiting list 187.

If there is some job information which is started to act, step S32 is selected. If not, step S37 is selected.

In step S32, a starting-time set unit 157 is operated to set a starting time within which to start to act the job as a starting time Td within which to start to act the latest job, and deletes the job information started to act from the job-waiting list 187. Then, the operation is returned to step S15.

In step S37, it is checked whether or not it takes the waiting-time count period ti starting from the count-starting time to.

If it does not take the waiting-time count period ti, step S38 is selected.

If it takes the waiting-time count period ti, step S41 is selected In step S33, the current time, when “NO” is decided by the check operation of step S15, is set to the current time Td. Thus, a time within which to determine that no piece of the job information is contained in the job-waiting list is set as the current time Td (182).

In step S34, a waiting-time count unit 158 is operated to count an elapsed time (Td-Ts) 183 from the stored start time Ts within which to start to use the job-waiting list to the current time Td.

In step S35, an accumulation-time count unit 159 is operated to accumulate the elapsed time (Td-Ts) 183 to an accumulation time tr within which to use the job-waiting list (tr=tr+(Td-Ts)).

The current time Td is the time within which to determine that no piece of the job information is contained in the job-waiting list, but essentially corresponds to a time when the job information is deleted from the job-waiting list and also a job-starting time when the job is started to act.

Again, the elapsed time (Td-Ts) 183 is counted from the start time Ts within which to start to use the job-waiting list by determining that there is a first job instruction and registering the job information of the first job instruction into the job-waiting list, into the current time Td (namely, essentially equal to a job-starting time within which to start to act the first job) by determining that the job information of the first job instruction is deleted and absent from the job-waiting list. This transitional time (Ts-Td) 183 is accumulated to the accumulation time tr within which to use the job-waiting list.

When a plurality of jobs are in the waiting state, the current time Td is a time when the last job remaining in the job-waiting list is started to act and then it is determined that the job information is absent in the job-waiting list.

In step S36, the accumulation time tr within which to use the job-waiting list is newly updated and “1” is set in the update flag fr (189) to indicate the update. Then, the operation is returned to step S11.

If it does not take the waiting-time count period ti starting from the count-starting time t0 in step S37, step S38 is selected in which it is checked whether or not there is a new job instruction. In step S38, the same operation as step S12 is performed.

If there is a new job instruction in step S38, step S39 is selected in which it is checked whether or not there is a job being in progress. In step S39, the same operation as step S13 is performed.

If there is no new job instruction in step S38 and there is no job being in progress in step S39, the operation is returned to step S15.

If there is a job being in progress in step S39, step S40 is selected.

In step S40, job information (the job identification ID) of a new job instruction and the current time are registered in the job-waiting list, and the operation is returned to step S15.

If it takes the waiting-time count period ti starting from the count-starting time t0 in step S37, step S41 is selected to set the current time to the current time Td.

In step S42, because it takes the waiting-time count period ti, the same operation as steps S34, S35 and S36 is performed even if the job information being pending remains in the job-waiting list. Namely, the elapsed time (Td-Ts) is counted in step S42, this elapsed time (Td-Ts) is accumulated to the accumulation time tr in step S43 (tr=tr+(Td-Ts)), and “1” is set in the update flag fr in step S44 (fr=1). Then, step S20 is selected.

In step S20, it is checked whether or not the update flag fr includes “1”. If fr=1, step S21 is selected. If fr≠1, the operation ends.

In step S21, a transitional-time set unit 160 is operated to substitute the present accumulation time tr within which to use the job-waiting list into the transitional time te (186) to the energy-saving mode, and then the operation ends.

Here, the transitional time te to the energy-saving mode is updated by a value presently stored in the accumulation time tr within which to use the job-waiting list.

On the other hand, if fr≠1 in step S20, the transitional time te to the energy-saving mode is left as the present value.

Moreover, after the transitional time te to the energy-saving mode is updated, it may be possible to reset to the initial value “0” the starting time Ts within which to use the job-waiting list and the accumulation time tr within which to use the job-waiting list.

The starting time Ts within which to use the job-waiting list is updated when the job information is initially registered in the job-waiting list in step S14, but may be reset to the initial value “0”, when the accumulation time tr within which to use the job-waiting list is updated in steps S35 and S43.

In the flow chart of FIG. 4, in the case where a job A is being in progress in the count period ti, when a job instruction of a next job B is entered, the job information (job identification ID) of the job B, and the current time (the registration time within which to register the job information) are registered in the job-waiting list.

Even if the job instruction of another job (C, D or the like) is entered before the actions of the jobs A and 13 have been finished, the starting time Ts stored for the first job B placed initially in the waiting state is maintained as such until all pieces of the job information registered in the job waiting list are absent.

When all pieces of the job information registered in the job waiting list are absent or it takes the count period ti, the accumulation time tr within which to use the job-waiting list is updated.

According to the present invention, with reference to the usage circumstance in the latest predetermined count period (ti) of the current time, the elapsed time (Td-Ts) is counted from the start time Ts within which to start to use the job-waiting list by determining that there is a job instruction placed in the waiting state and registering the job information of the job instruction in the waiting state into the job-waiting list, into the current time Td (namely, essentially equal to a job-starting time within which to start to act the latest job placed in the waiting state) by determining that the job information of the job instruction is deleted and absent from the job-waiting list.

With this configuration of the present invention, it is possible for the transitional time to the energy-saving mode to adapt almost real-time a suitable value for optimizing both the energy-saving effect and the convenience of the operator.

### <Specific Example of Setting a Transitional Time to the Energy-Saving Mode>

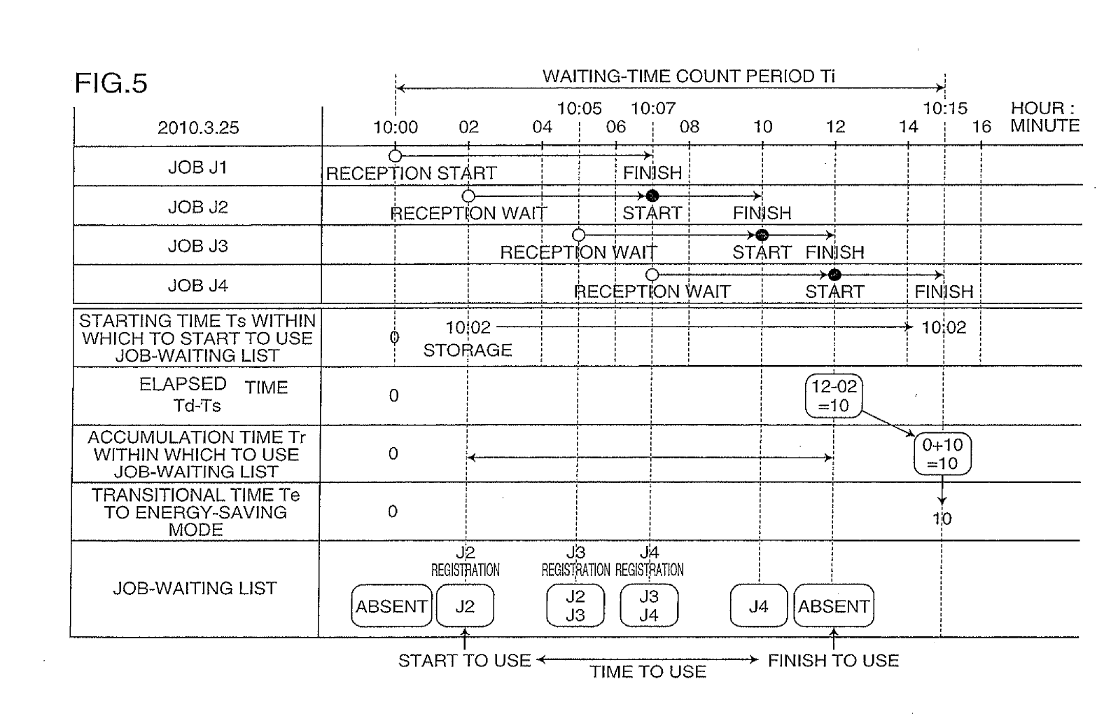

FIG. 3 is an explanation diagram illustrating a specific example of updating a transitional time to an energy-saving mode from starting a count operation of a job-waiting time according to the present invention. FIG. 5 is a time chart illustrating job operation steps according to a preferred embodiment of the present invention.

In this example, a count-starting time t0 is set to be 10:00 on Mar. 25, 2010. A waiting-time count period ti is set to be 15 minutes.

Then, the waiting time is counted from 10:00 to 10:15 on Mar. 25, 2010.

A transitional time te to the energy-saving mode is set to be 0 minute. An accumulation time tr within which to use the job-waiting list and the update flag fr are initialized to be “0” (step S10).

Further, there is no job being in progress, and no job information is stored in the job-waiting list.

FIG. 3-1 illustrates various information at a count-starting condition on 10:00 on Mar. 25, 2010.

In the condition of FIG. 3-1, a first job instruction J1 (e.g., a print instruction) is entered from the first host computer 200 on 10:00.

In this case, steps S12 and S13 of FIG. 4 are selected. Since there is no job in progress, the first job instruction in step S22 is started to act, and the operation is returned to step S11.

A job identification (ID) of the first job instruction is assumed to be “PR1-000000”, and the job identification (ID), “PR1-000000”, of the job being in progress is stored.

Since the job is instantly started to act without being waiting in this case, the job information of the first job instruction J1 is not registered in the job waiting list.

Accordingly, as shown in FIG. 5, none of the starting time Ts within which to use the job-waiting list, the accumulation time tr within which to use the job-waiting list and the transitional time te to the energy-saving mode are updated as the present value.

FIG. 3-2 illustrates various information at 10:02 on Mar. 25, 2010.

It is assumed that the first job instruction J1 is still in progress at 10:02, and that a second job instruction (e.g., a print instruction, and a job identification (ID) of the second job instruction is “PR2-000000”) is entered from the second host computer 300 on 10:02.

In this case, steps S12 and S13 of FIG. 4 are selected. Since there is the job instruction J1 being in progress, and step S14 is selected in which the job information (the job identification (ID)) of the second job instruction J2 is registered in the job-waiting list.

The current time (10:02) also is registered to the job-waiting list as a starting time Ts within which to use the job-waiting list.

Accordingly, one job, namely, the second job instruction J2 is placed in the waiting state, and the usage of the job waiting list is started which commences to count an accumulation time tr within which to use the job-waiting list.

Then, steps S14 and S15 of FIG. 4 are selected. Since there is a job placed in the waiting state, step S31 is selected. Steps S15, S31 and S37 to S40 are looped until there is no job placed in the waiting state.

FIG. 3-3 illustrates various information at 10:05 on Mar. 25, 2010.

It is assumed that the first job instruction J1 is still in progress at 10:05, and that a third job instruction (e.g., a print instruction, and a job identification (ID) of the third job instruction is “SCN-000000”) is entered from the scanner 105 on 10:05.

In this case, because the first job instruction J1 is still in progress, and the third job instruction J3 is placed in the waiting state.

That is, step S38 in FIG. 4 is operated to determine the reception of the third job instruction J3, and step S39 is operated to determine that there is the job instruction (J1) placed in the waiting state, so that further step S40 is operated to register the job information of the third job J3 in the job waiting list.

Since the job waiting list has the job information of the second job yet, the job information (the job identification (ID) of the third job instruction, and the current time=10:05) is registered.

In FIG. 3-3, step S40 of FIG. 4 is selected to return to step S15, and eventually step S31. No accumulation time tr within which to use the job-waiting list or the like is counted. Namely, the accumulation time tr within which to use the job-waiting list and the transitional time te to the energy-saving mode are left “0 minute”, yet.

However, the starting time Ts within which to use the job-waiting list is left 10:02 (Ts=10:02).

FIG. 3-4 illustrates various information at 10:07 on Mar. 25, 2010.

It is assumed that the action of the first job instruction J1 has been finished and the second job instruction J2 is started to act, and that a fourth job instruction (e.g., a print instruction, and a job identification (ID) of the fourth job instruction J4 is “PR1-000001”) is entered from the first host computer 200.

At this time, since the first job J1 has been finished and the second job J2 is started to act, step S32 of FIG. 4 is selected. Step S32 is operated to delete the job information of the second job J2 from the job waiting list because the second job instruction J2 is started to act. Further, the present job identification (ID) of the first job instruction is altered to the job identification (ID), “PR2-000000” of the second job J2.

Further, since the fourth job instruction J4 is entered, but the second job instruction J2 is being in progress, step S31 of FIG. 4 is moved to steps S38 and S39, and step 40 is selected to register the job information (the job identification (ID)=PR1-000001, and the current time=10:07 on Mar. 25, 2010) of the fourth job J4 to the job waiting list.

That is, as shown in FIG. 3-4, the job information of the third job J3 and the fourth job J4, which are placed presently in the waiting state, are registered in the job waiting list.

Also, the starting time Ts within which to use the job-waiting list is left 10:02 (Ts=10:02) without being reset.

FIG. 3-5 illustrates various information at 10:10 on Mar. 25, 2010.

At 10:10, it is assumed that the action of the second job instruction J2 has been finished and the third job instruction J3 is started to act.

This time, since the action of the second job instruction J2 has been finished and the third job instruction J3 is started to act, step S32 of FIG. 4 is operated to delete the job information of the third job J3 from the job waiting list.

Further, the present job identification (ID) of the second job J2 is altered to the job identification (ID) of the third job J3.

Accordingly, in FIG. 3-5, the fourth job J4 only is placed in the waiting state.

FIG. 3-6 illustrates various information at 10:12 on Mar. 25, 2010.

At 10:12, it is assumed that the action of the third job instruction J3 has been finished and the fourth job instruction J4 is started to act.

This time, since the fourth job instruction J4 is started to act, step S32 of FIG. 4 is operated to delete the job information of the fourth job J4 from the job waiting list.

Further, the present job identification (ID) of the third job J3 is altered to the job identification (ID) of the fourth job J4.

Accordingly, the job waiting list has no job information. Since all the job information registered in the job waiting list is absent, step S15 is operated to detect this, and then step S33 is selected.

After step S33 is operated and because, as shown in FIG. 3-6, the previous accumulation time tr=0 minute, the current time Td=10:12, and the starting time Ts=10:02, step S35 of FIG. 4 is operated to count the accumulation time tr within which to use the job-waiting list. That is, by calculating tr=tr+(Td-Ts), the accumulation time tr is 10 minutes (tr=10 minutes). Then, after step S36 is selected, the operation is returned to step S11.

FIG. 3-7 illustrates various information at 10:15 on Mar. 25, 2010 when it takes the predetermined waiting-time count period ti (=15 minutes).

At 10:15, it is assumed that the action of the fourth job instruction J4 as the last job has been finished. In this case, steps S11 and S20 are selected in the operation of FIG. 4.

Since the update flag fr=1, step S21 is selected to substitute the current accumulation time tr (10 minutes) into the transitional time te to the energy-saving mode so that te=10 minutes.

Accordingly, although the count operation is started in FIG. 3-1 in which the transitional time te to the energy-saving mode is “0 minute”, the four job instructions (J1-J4) are entered within the count period ti of 15 minutes, and the three jobs (J2-J4) are placed in the waiting state, so that the transitional time te to the energy-saving mode is updated to be 10 minutes.

Thereafter, based on this transitional time te to the energy-saving mode, a transitional operation to the energy-saving mode is performed.

In the present invention, when the transitional time te to the energy-saving mode is dynamically set, the accumulation time tr within which to use the job-waiting list within the waiting-time count period ti is set large, which means that the number of the jobs placed in the waiting state and the waiting-times are also enlarged.

Accordingly, the transitional time te to the energy-saving mode is set a suitable large value (time) enough to consider the convenience of the operator.

Namely, after the transitional time te to the energy-saving mode is set large, the convenience of the operator is focused rather than the energy-saving effect.

On the other hand, when the accumulation time tr within which to use the job-waiting list within the waiting-time count period ti is set small, which means that the number of the jobs placed in the waiting state and the waiting-times are also small.

Accordingly, the transitional time te to the energy-saving mode is set a suitable small value (time) enough to consider the energy-saving effect.

Namely, after the transitional time te to the energy-saving mode is set small, the energy-saving effect is focused rather than the convenience of the operator.

As illustrated in FIG. 3-1 to FIG. 3-7, according to the present invention, the transitional time te to the energy-saving mode is updated using the actual waiting time of the waited job within the count period (ti) among the past condition of usage. Accordingly, even if a condition of usage occurs which is largely different from the ordinary frequency of usage, the new condition of usage is considered in updating the transitional time te to the energy-saving mode.

Therefore, as corresponding to the present status, a suitable transitional time te to the energy-saving mode is set to optimize both the energy-saving effect and the convenience of the operator.

In the specific example, the waiting-time count period ti is exemplified 15 minutes, but should not be limited thereto. It is possible for the operator to be able to change this count period as necessary.

The shorter the count period ti is set, the energy-saving setting is possible in which the later the latest condition of usage is considered.

The longer the count period ti is set, the energy-saving setting is possible in which the later not only the latest condition of usage is considered, but also the longer a long-term condition of usage is considered.

Therefore, it is preferable that the count period ti be set as short as possible in order to set in a real time a transitional time te to the energy-saving mode by considering the latest condition of usage as late as possible.

Also, the shorter the count period ti is set, the energy-saving setting is established in which the later the latest condition of usage is considered regardless the long-term condition of usage.

On the other hand, the longer the count period ti is set, the energy-saving setting is established in which the longer the long-term condition of usage is considered regardless so much the abrupt change in the latest condition of usage.

Various modifications are possible for the present invention other than the aforesaid embodiment. It should not be construed that the modifications do not belong to the scope of the present invention. The present invention should include the meaning equivalent to the claims and all modifications within the scope of the present invention.

What is claimed is:

1. An image forming apparatus comprising:
a storage unit for storing a job-waiting list in which job information of a job in a waiting state among a plurality of jobs received for image forming is registered, and a transitional time within which to transit from a waiting mode to an energy-saving mode;
a waiting list control unit for controlling to register to the job-waiting list the job information of the job instructed to act within a predetermined count time, when a job is being in progress, and controlling to store into the storage unit a time within which to initially register the job information to the job-waiting list;
an accumulation-time count unit for, in the case where it is determined that all the job information stored in the job-waiting list has been absent, counting an accumulation time obtained by accumulating an elapsed time, in the predetermined count period, the elapsed time being counted from a time when the job information is registered to the job-waiting list to a time when all the job information registered in the job-waiting list has been absent after start of processing of the last job registered in the job-waiting list; and
a transitional-time set unit for setting the transitional time based on the counted accumulation time.

2. An image forming apparatus comprising:
a reception unit for receiving job instruction for image forming;
a storage unit for storing a transitional time within which to transit from a waiting mode to an energy-saving mode in the case of continuing a condition without receiving the job instruction, job information of a received job, a job-waiting list registering the job information of a job being in a waiting state, and a start time Ts within which to start to use the job-waiting list;
a determination unit for determining whether or not the job being in progress is present;
a waiting list control unit for, in the case where the reception unit receives a request for processing of a first job and the determination unit determines that a second job is being in progress, controlling to register to the job-waiting list the job information of the first job, and controlling to store to the storage unit a time when that job information is registered to the job-waiting list as the start time Ts;
a job-waiting determination unit for determining whether or not the job-waiting list has the job information;
a job-starting determination unit for, in the case where the job-waiting determination unit determines that the job-waiting list has the job information, determining whether or not processing of the job determined to be in the job-waiting list is started;
a starting-time set unit for, in the case where the job-starting determination unit determines that processing of the job is started, setting a starting time when the processing of the job is started as the latest job starting time Td;
a waiting-time count unit for, in the case where the job-waiting determination unit determines that the job information is absent in the job-waiting list, counting an elapsed time (Td-Ts) from the start time Ts stored in the storage unit to the latest job-starting time Td;
an accumulation-time count unit for counting an accumulation time tr in a predetermined count period by accumulating the elapsed time counted by the waiting-time count unit; and
a transitional-time set unit for setting the transitional time based on the counted accumulation time.

3. The image forming apparatus according to claim 1 or 2, wherein the accumulation time accumulated in the predetermined count period is set to the transitional time, upon the termination of the predetermined count period.

4. The image forming apparatus according to claim 1 or 2, wherein the predetermined count period is stored in the storage unit such that the predetermined count time is changeable.

5. The image forming apparatus according to claim 3, wherein the predetermined count time is stored in the storage unit such that the predetermined count time is changeable.

6. A program allowing a computer to perform the following functions comprising:
a storage function for storing a job-waiting list in which job information of a job in a waiting state among a plurality of jobs received for image forming is registered, and a transitional time within which to transit from a waiting mode to an energy-saving mode;
a waiting list control function for controlling to register to the job-waiting list the job information of the job instructed to act within a predetermined count time, when a job is being in progress, and controlling to store a time within which to initially register the job information to the job-waiting list;
an accumulation-time count function for, in the case where it is determined that all the job information stored in the job-waiting list has been absent, counting an accumulation time obtained by accumulating an elapsed time, in the predetermined count period, the elapsed time being counted from a time when the job information is registered to the job-waiting list to a time when all the job information registered in the job-waiting list has been absent after start of processing of the last job registered in the job-waiting list; and
a transitional-time set function for setting the transitional time based on the counted accumulation time.
